(19) United States
(12) Patent Application Publication
(10) Pub. No.: US 2004/0190428 A1
(43) Pub. Date: Sep. 30, 2004

(54) Optical device molding die designing method

(75) Inventors: Takashi Ito, Saitama-shi (JP); Masayuki Murakami, Saitama-shi (JP); Yu Kitahara, Saitama-shi (JP)

Correspondence Address: Ronald R. Snider, P.O. Box 27613, Washington, DC, 20038-7613, US

(73) Assignee: Fuji Photo Optical Co., Ltd., Saitama-shi (JP)

(21) Appl. No.: 10/799,685

(22) Filed: Mar. 15, 2004

(30) Foreign Application Priority Data
Mar. 28, 2003 (JP) JP2003-092651

(51) Int. Cl. G11B 7/00

(52) U.S. Cl. 369/112.07; 369/121

(57) ABSTRACT

An optical device molding die designing method measures a wavefront aberration amount (Δ) of an optical device molded by a temporary die, calculates a correction wavefront aberration amount (−Δ) compensating for the wavefront aberration amount (Δ), optically designs the optical device again by optimizing its form so as to generate the correction wavefront aberration amount (−Δ), and designs a normal die accordingly.

### RELATED APPLICATIONS

This application claims the priority of Japanese Patent Application No. 2003-092651 filed on Mar.28, 2003, which is incorporated herein by reference.

### BACKGROUND OF THE INVENTION

1. Field of the Invention

The present invention relates to a method of designing an optical device molding die. More specifically, the present invention relates to a method of designing a molding die for molding an optical device whose form must be designed by using a number of optical parameters.

2. Description of the Prior Art

Conventionally, various optical designing techniques for carrying out an optimizing process so as to attain a desirable target value by using a number of parameters in order to yield a desirable optical device have been developed. However, no matter how strict optical designing is carried out, it is hard to yield a desirable optical device unless favorable molding is effected by a molding die for the optical device.

In general, because of thermal shrinkage during a cooling period after the molding, the form of the molding die and the form of the optical device molded by the molding die do not coincide with each other. In case of such a discrepancy, an optical surface die form proportionally enlarging a desired article may be used as shown in FIG. 4 if the forms are similar to each other. However, because of unevenness in the temperature distribution within the glass material at the time of molding, differences in thickness among individual parts of the article, and the like, the individual parts of the article may differ from each other in terms of the amount of thermal shrinkage as shown in FIG. 5, for example.

Therefore, a method in which the surface form of an optical device obtained by molding is measured, changes in the form caused by molding are estimated according to thus measured data, and the form of the molding die is optimized while correcting the molding die has conventionally been employed. Namely, as shown in FIG. 6, the method comprises the steps of (1) carrying out optical designing so as to yield a favorable optical performance; (2) making a temporary die and temporarily molding an optical device according to the optically designed value; (3) measuring the temporarily molded optical device and calculating a deviation of an optical performance thereof from a reference value; (4) correcting, according to the calculated amount of deviation, the molding die into a form expecting the amount of deviation; (5) carrying out final molding by thus corrected molding die; and (6) verifying an optical performance of the finally molded optical device.

The prior art disclosed in Japanese Unexamined Patent Publication No. 2002-96344 (Patent Reference 1) is based on and improves such a method. Namely, an optical characteristic of a temporary lens once molded is measured, the amount of deviation of thus measured value from a reference value is compared with a table prepared beforehand, so as to determine an amount to adjust the molding die, and a final molding die (normal die) is designed according to the amount of adjustment.

However, the prior art disclosed in the above-mentioned Patent Reference 1 cannot deal with unexpected aberrations, since the amount to adjust the molding die is determined according to the predetermined table concerning the amount of deviation of the measured optical characteristic value of the temporary lens from the reference value.

Depending on the table such as the one disclosed in the above-mentioned Patent Reference 1, the number of parameters which can be inputted is limited. Therefore, when a number of parameters such as high-order aspheric surface forms and free curved surface forms are required in particular, it is hard to deal with such a number of parameters at the same time. Even when a plurality of tables is provided, it is quite difficult to obtain an optimal amount of adjustment in response to parameters changing in relation to each other. As a result, the finally obtained molding die has not always been capable of yielding an optical device which can favorably correct aberrations.

### SUMMARY OF THE INVENTION

In view of such circumstances, it is an object of the present invention to provide an optical device molding die designing method which can design a molding die adapted to deal with the occurrence of unexpected aberration finely and yield an optical device which can favorably correct aberrations.

The present invention provides a method of designing a molding die for molding an optical device having a desirable form optimized so as to yield a desirable wavefront aberration by using a plurality of optical parameters;

the method comprising the steps of:

designing and making, according to the optimized form of the optical device, a temporary molding die for molding the optical device;

molding a first temporary optical device by using the temporary molding die;

measuring a wavefront aberration of thus molded first temporary optical device;

calculating a correction wavefront aberration compensating for the wavefront aberration;

designing by using at least the plurality of optical parameters a second temporary optical device for optimizing a form so as to exhibit the correction wavefront aberration; and

designing, according to the optimized form of the second temporary optical device, a normal molding die for molding a normal optical device.

In this case, the method may further comprise the steps of:

molding the normal optical device by using the normal molding die;

measuring a wavefront aberration of thus molded optical device; and

recalculating the correction wavefront aberration when the wavefront aberration has a value greater than a predetermined reference value, and repeating subsequent steps until the value of the correction wavefront aberration becomes the reference value or less.

Preferably, the wavefront aberration and correction wavefront aberration are measured by using an interferometer apparatus for measuring a transmitted wavefront.

When an irregular wavefront aberration is seen, it is preferred that a plurality of wavefront aberration amounts be measured in a plurality of divided areas, respectively, and respective correction wavefront aberration amounts be calculated for thus measured plurality of wavefront aberration amounts.

The optical device molding die designing method of the present invention is particularly useful in the case where at least one surface of the optical device is an aspheric surface, and the like.

The optical device may be a single lens, used for an optical pickup objective lens, having aspheric surfaces on both sides.

The molding die may be used for press molding or injection molding.

### BRIEF DESCRIPTION OF THE DRAWINGS

FIG. 1 is a chart for explaining steps of the optical device molding die designing method in accordance with an embodiment of the present invention;

FIG. 2 is a flowchart for summarizing the optical device molding die designing method in accordance with the embodiment of the present invention;

FIGS. 3A and 3B are a view showing an interference fringe image and a partly enlarged view thereof, respectively, for explaining an embodiment different from that shown in FIG. 1;

FIG. 4 is a schematic view for explaining an example of discrepancy between a form of a molding die and a form of an optical device molded by the molding die;

FIG. 5 is a schematic view for explaining an example of discrepancy between a form of a molding die and a form of an optical device molded by the molding die; and

FIG. 6 is a view for explaining steps of a conventional optical device molding die designing method.

### DESCRIPTION OF THE PREFERRED EMBODIMENTS

In the following, the optical device molding die designing method in accordance with an embodiment of the present invention will be explained with reference to the drawings. In this embodiment, a method of designing a molding die for molding a single lens, used for an optical pickup objective lens, having aspheric surfaces on both sides will be explained by way of example.

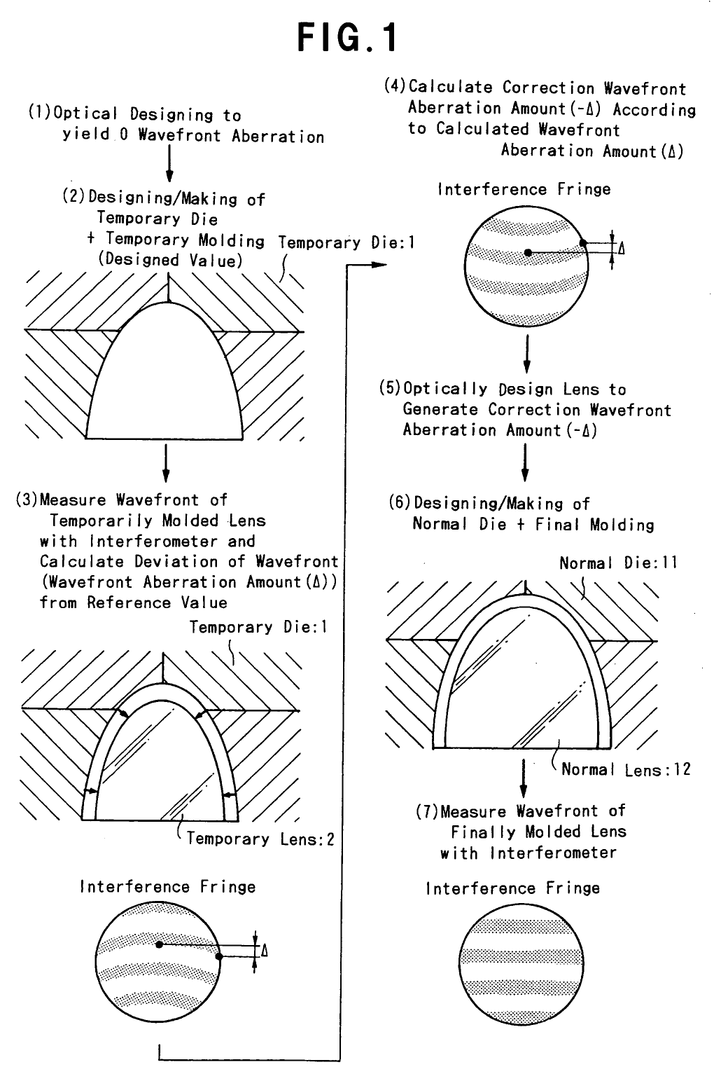

FIG. 1 is a schematic flowchart for explaining the method in accordance with this embodiment. In the following, steps (1) to (7) will be explained successively.

(1) First Step

Optical designing for a desirable aspherical lens is carried out by optimizing a form so as to yield a desirable amount of wavefront aberration, e.g., 0.

Here, the optical designing refers to an operation for yielding a desirable lens characteristic (target) according to a number of optical parameters, and handles mapping from a parameter space in which such optical parameters exist onto a target space in which such a target exists. In general, examples of the parameters include the center curvature of a refractive surface, surface spaces, and glass species, whereas examples of the target include paraxial tracing values, ray-tracing values, and forms.

The optical designing of this embodiment aims at obtaining a lens having aspheric surface forms (on both sides) represented by the following aspheric surface expression (1):

$$Z = \frac{C}{1 + \sqrt{1 - {kC}^{2} {Y}^{2}}} {Y}^{2} + {\sum }_{i = 2}^{5} {A}_{2 i} {Y}^{2 i}$$

where

Z is the depth;

Y is the height from the optical axis;

k is the eccentricity; and

C is the curvature;

whose form is optimized so as to yield a wavefront aberration amount of 0. Therefore, optical parameters include at least the elements C, k, and A₂ᵢ (i=2 to 5) for each aspheric surface in the aspheric surface expression, and the thickness of the lens. Hence, at least 13 optical parameters exist in total.

(2) Second Step

A temporary die 1 for yielding the aspherical lens optically designed in the first step is designed and made, and an aspherical lens is temporarily molded by the temporary die 1, so as to yield a temporary lens 2.

Because of the thermal shrinkage upon molding and the like, the temporary lens 2 has a form different from that of the temporary die 1, whereby the wavefront aberration is not usually 0.

(3) Third Step

The transmitted wavefront of the temporary lens 2 obtained by the temporary molding is measured by an interferometer, and the amount of deviation of the wavefront (wavefront aberration amount (Δ)) from a reference value is calculated. The wavefront aberration amount (Δ) is determined from the deviation of interference fringes from their linearity or the like as shown in the interference fringe image of (3).

When the wavefront aberration amount (Δ) is not greater than a predetermined reference value, the temporary die 1 can be used as a normal die. For an aspherical lens requiring a high optical performance and the like, the predetermined reference value is set to a very small value, whereby the following steps are usually carried out in succession.

(4) Fourth Step

According to the wavefront aberration amount (Δ) calculated in the third step, a correction wavefront aberration amount (−Δ) which can compensate for the wavefront aberration amount (Δ) is calculated.

When expressed so as to correspond to the interference fringe image of (3), the correction wavefront aberration amount (−Δ) becomes the deviation of interference fringes symmetrical to those of (3) from their linearity and the like as shown by the interference fringe image of (4).

(5) Fifth Step

Optical designing of an aspherical lens is carried out by optimizing its form so as to generate a wavefront aberration with the correction wavefront aberration amount (−Δ) determined by the fourth step.

The optical designing in the fifth step is carried out by using the same technique as that of the first step mentioned above. Namely, optical parameters include at least the elements C, k, and A₂ᵢ (i=2 to 5) for each aspheric surface in the above-mentioned aspheric surface expression, and the thickness of the lens, whereby at least 13 optical parameters exist in total as in the first step. On the other hand, the target is in such a form as to generate the wavefront aberration amount (−Δ). In the fifth step, the optical designing may be carried out while adding optical parameters to those used in the first step.

When such a large number of optical parameters exist, using the same technique as that of initial lens designing is essential for the final lens to attain excellent optical performances.

(6) Sixth Step

A normal die 11 corresponding to the form of the aspherical lens optically designed in the fifth step is designed and made, and an aspherical lens is finally molded by the normal die 11, so as to yield a normal lens 12.

(7) Seventh Step

The transmitted wavefront of the normal lens 12 obtained by the final molding is measured by an interferometer, and the amount of deviation of the wavefront (wavefront aberration amount (Δ)) from the reference value is calculated as in the third step, so as to evaluate the normal die 11.

Fringes with a favorable linearity must usually be seen as shown in the interference fringe image of (7) when thus obtained normal lens 12 is measured by the interferometer. In this case, it can be determined that the die is also a normal die 11 which can mold a lens having a desirable optical characteristic.

When the wavefront aberration amount (Δ) is greater than a predetermined reference value, the fourth and later steps can successively be carried out again.

Thus, according to the wavefront aberration amount (Δ) temporarily molded by the temporary die 1, a correction wavefront aberration amount (−Δ) which can compensate for the wavefront aberration amount (Δ) is calculated, and a lens which can generate the correction wavefront aberration amount (−Δ) is optically designed again in this embodiment. This can yield a normal die 11 which can favorably deal with the occurrence of unexpected aberrations and finally mold a lens having quite favorable aberrations.

Such effects are substantially hard to obtain when simply determining the amount to adjust a die by using a table according to a part of optical parameters.

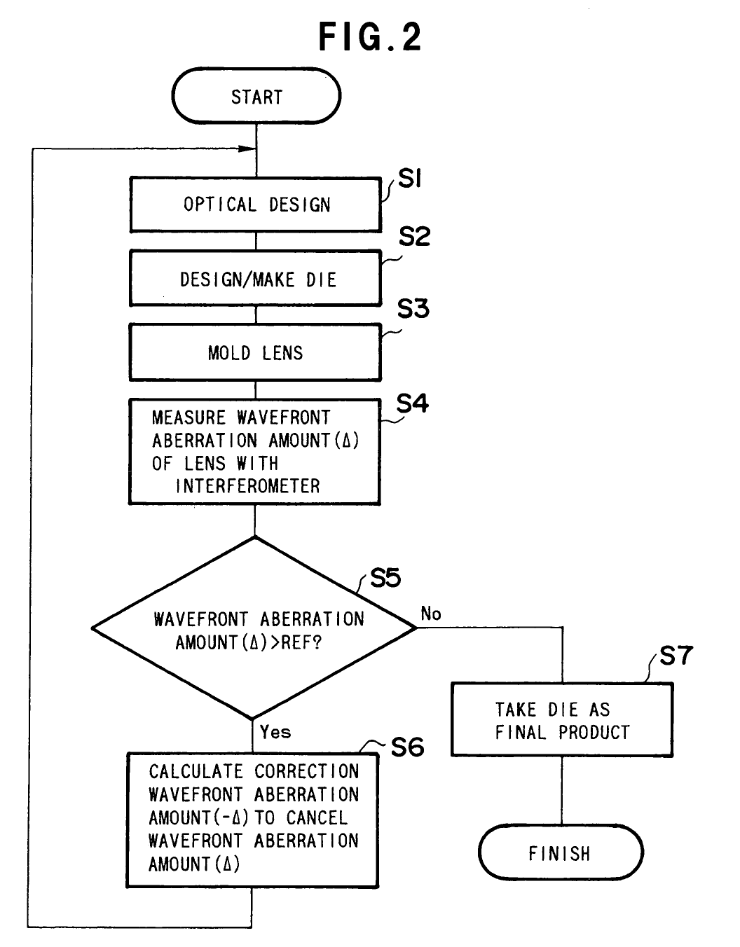

FIG. 2 is a flowchart for making it easier to understand the method of this embodiment.

First, a desirable aspherical lens is optically designed by optimizing its form so as to yield a wavefront aberration of 0 (S1), a die (temporary die 1) is designed and made according to the result of optical designing (S2), an aspherical lens is molded (temporarily molded) by using the die (temporary die 1) (S3), and the transmitted wavefront of thus obtained aspherical lens (temporary lens 2) is measured with an interferometer, so as to measure its wavefront aberration amount (Δ) (S4).

Subsequently, it is determined whether the measured wavefront aberration amount (Δ) is greater than a predetermined reference value or not (S5). If it is determined that the wavefront aberration amount (Δ) is greater than the predetermined reference value, a correction wavefront aberration amount (−Δ) which compensates for the wavefront aberration amount (Δ) is calculated (S6), and the flow returns to S1.

By using the same optical parameters as those in the initial optical designing with additional optical parameters if necessary, an aspherical lens is optically designed by optimizing its form such that its wavefront aberration coincides with the correction wavefront aberration amount (−Δ) (S1), a die (normal die 11) is designed and made according to the result of optical designing (S2), an aspherical lens is molded (finally molded) by using this die (normal die 11) (S3), and the transmitted wavefront of thus obtained aspherical lens (normal lens 12) is measured with an interferometer, so as to measure the wavefront aberration amount (Δ) (S4).

Thereafter, it is determined whether the measured wavefront aberration amount (Δ) is greater than the above-mentioned predetermined reference value or not (S5). If it is determined that the wavefront aberration amount (Δ) does not exceed the predetermined reference value, thus produced die (normal die 11) is taken as a finished product (S7).

If it is determined that the wavefront aberration amount (Δ) is greater than the predetermined reference value in S5 again, a correction wavefront aberration amount (−Δ) which compensates for the wavefront aberration amount (Δ) is calculated again (S6), and the flow returns to S1, so as to repeat the subsequent processing.

If it is determined that the wavefront aberration amount (Δ) does not exceed the predetermined reference value in the first operation of S5, the produced die (temporary die 1) is taken as a finished product (S7).

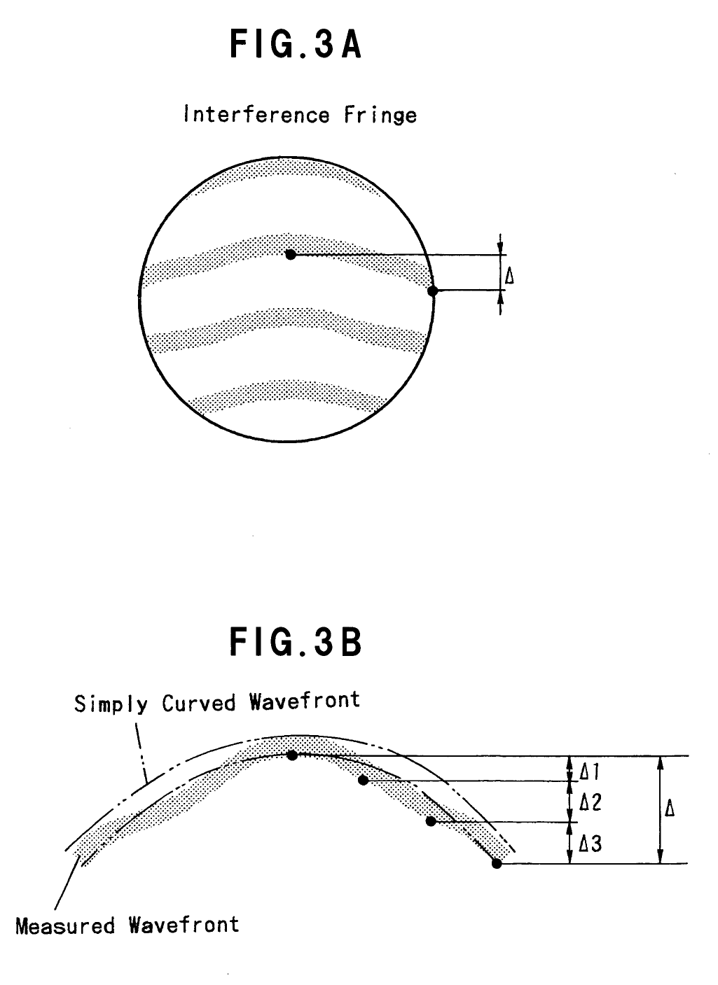

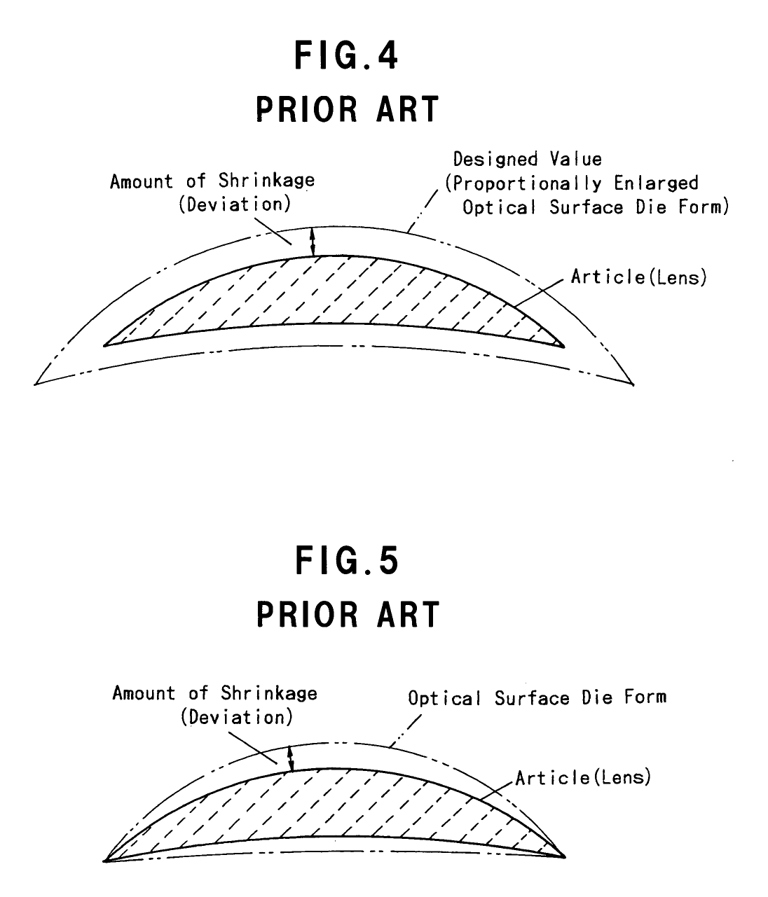

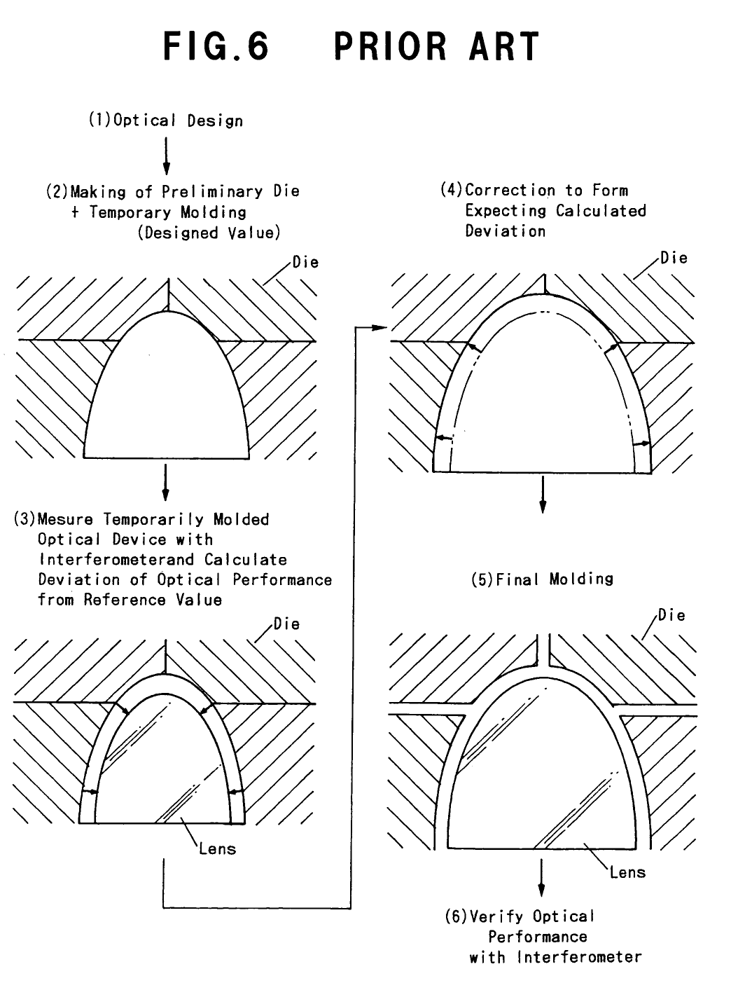

In the above-mentioned method of the embodiment, a correction wavefront aberration amount (−Δ) is calculated according to the measured wavefront aberration amount (Δ), and an aspherical lens which can generate the correction wavefront aberration amount (−Δ) is optically designed. When the tendency (curving) of wavefront aberration differs from a simple curve as shown in FIG. 3A although the measured aberration amount (Δ) attains a desirable value in total, it is preferred that a plurality of wavefront aberration amounts (Δ1, Δ2, Δ3, . . . ) be measured in a plurality of divided areas in the single wavefront, respectively, and that the processing explained in the above-mentioned embodiment be carried out according to each of the plurality of aberration amounts (Δ1, Δ2, Δ3, . . . ).

In this case, even when the tendency of wavefront aberration differs from a simple curve although the measured aberration amount (Δ) attains a desirable value in total, a normal die which can mold an optical device exhibiting higher performances can be obtained in conformity to the tendency of wavefront aberration.

Without being restricted to the embodiments mentioned above, the optical device molding die designing method of the present invention can be modified in various manners. For example, though the above-mentioned embodiments relate to the case where the present invention is applied to a molding die for molding a single lens, used for an optical pickup objective lens, having aspherical lenses on both sides, the method of the present invention is not limited thereto and is applicable to molding dies for molding various lenses made of glass and plastics in general.

While a molding die is constituted by a plurality of parts, e.g., upper and lower dies, the present invention can also be applied to a part of the die.

The molding die in the present invention may be employed for various kinds of molding such as press molding and injection molding.

As explained in the foregoing, the optical device molding die designing method of the present invention measures a wavefront aberration amount (Δ) of an optical device molded by a temporary die, calculates a correction wavefront aberration amount (−Δ) which can compensate for the wavefront aberration amount (Δ), optically designs the optical device again by optimizing its form so as to generate the correction wavefront aberration amount (−Δ) according to the same technique as with the initial optical designing, and designs a normal die accordingly.

Therefore, unlike the conventional technique in which an amount to adjust a die is simply determined by using a table according to a part of optical parameters, the present invention can yield a normal die which can favorably deal with the occurrence of unexpected aberrations and finally mold an optical device having quite favorable aberrations.

What is claimed is:

1. A method of designing a molding die for molding an optical device having a desirable form optimized so as to yield a desirable wavefront aberration by using a plurality of optical parameters;
the method comprising the steps of:
designing and making, according to the optimized form of the optical device, a temporary molding die for molding the optical device;
molding a first temporary optical device by using the temporary molding die;
measuring a wavefront aberration of thus molded first temporary optical device;
calculating a correction wavefront aberration compensating for the wavefront aberration;
designing by using at least the plurality of optical parameters a second temporary optical device for optimizing a form so as to exhibit the correction wavefront aberration; and
designing, according to the optimized form of the second temporary optical device, a normal molding die for molding a normal optical device.

2. A method according to claim 1, further comprising the steps of:
molding the normal optical device by using the normal molding die;
measuring a wavefront aberration of thus molded optical device; and
recalculating the correction wavefront aberration when the wavefront aberration has a value greater than a predetermined reference value, and repeating subsequent steps until the value of the correction wavefront aberration becomes the reference value or less.

3. A method according to claim 1, wherein the wavefront aberration and correction wavefront aberration are measured by using an interferometer apparatus for measuring a transmitted wavefront.

4. A method according to claim 1, wherein a plurality of wavefront aberration amounts are measured in a plurality of divided areas, respectively, and respective correction wavefront aberration amounts are calculated for thus measured plurality of wavefront aberration amounts.

5. A method according to claim 1, wherein at least one surface of the optical device is an aspheric surface.

6. A method according to claim 1, wherein the optical device is a single lens, used for an optical pickup objective lens, having aspheric surfaces on both sides.

7. A method according to claim 1, wherein the molding die is used for press molding or injection molding.
